(19) United States
(12) Patent Application Publication
(10) Pub. No.: US 2025/0262962 A1
(43) Pub. Date: Aug. 21, 2025

(54) ANCHOR, ANCHOR ASSEMBLY, AND PEDESTAL FOR USE WITH AN ANCHOR OR ANCHOR ASSEMBLY

(71) Applicant: Hubbell Incorporated, Shelton, CT (US)

(72) Inventor: David Bruce, Oakland, FL (US)

(21) Appl. No.: 19/055,173

(22) Filed: Feb. 17, 2025

Related U.S. Application Data
(60) Provisional application No. 63/554,736, filed on Feb. 16, 2024.

(51) Int. Cl. B60L 53/30; E02D 5/80

(52) U.S. Cl. CPC B60L 53/30; E02D 5/80

(57) ABSTRACT

An anchor including an anchor that has an anchor body having a first end having a pointed tip, a second end opposite the first end, a wall defined between the first end and the second end, a helical plate coupled to the wall adjacent to the first end, and an aperture in the wall of the anchor body. The first aperture is positioned between the helical plate and the second end, and the first aperture is configured to receive one or more wires therethrough. The anchor body is configured to couple to a housing of a charger of an electric vehicle.

### CROSS-REFERENCE TO RELATED APPLICATIONS

This application claims priority to U.S. Provisional Patent Application No. 63/554,736, filed on Feb. 16, 2024, the entire contents of which is incorporated herein by reference.

### FIELD

The present application relates to an anchor configured to be inserted into the ground and to mechanically couple and electrically power an electric device. The present application is also directed to structure that is useable with the anchor and configured to mechanically couple and electrically power an electric device.

### SUMMARY

In some aspects, the techniques described herein relate to an anchor assembly including: an anchor including an anchor body having a first end having a pointed or inclined tip, a second end opposite the first end, a wall defined between the first end and the second end, a helical plate coupled to the wall adjacent to the first end, and an aperture in the wall of the anchor body, the aperture positioned between the helical plate and the second end, the aperture configured to receive one or more wires therethrough, and an attachment member that is removably couplable to the second end of the anchor body, the attachment member including a mounting plate having an opening configured to be in communication with an interior of the anchor body, the opening configured to receive the one or more wires from the interior of the anchor body, wherein the anchor body is configured to be partially inserted into a ground via rotation of the mounting plate which causes rotation of the anchor body such that the helical plate advances the anchor body into the ground, and wherein the mounting plate is configured to mechanically couple to a housing of an electric device or a pedestal for coupling the housing of the electric device while the one or more wires are mechanically and electrically coupled to the electric device to power the electric device.

In some aspects, the techniques described herein relate to an anchor assembly, wherein the attachment member further includes a hollow body having a first end and a second end opposite the first end, the mounting plate coupled to the second end such that the opening is in communication with an interior of the hollow body.

In some aspects, the techniques described herein relate to an anchor assembly, wherein the hollow body includes a first engagement interface that is configured to matingly engage with a second engagement interface of the anchor body.

In some aspects, the techniques described herein relate to an anchor assembly, wherein the hollow body includes a first threaded interface that is configured to matingly engage with a second threaded interface of the anchor body.

In some aspects, the techniques described herein relate to an anchor assembly, wherein one of the hollow body and the anchor body includes a detent aperture and the other of the hollow body and the anchor includes a detent that is configured to be removably received in the detent aperture to couple the hollow body to the anchor body.

In some aspects, the techniques described herein relate to an anchor assembly, wherein the hollow body is coupled to the anchor body via a fastener.

In some aspects, the techniques described herein relate to an anchor assembly, wherein the attachment member is a first attachment member and the mounting plate is a first mounting plate and wherein the first attachment member is interchangeable with second attachment member that is removably couplable to the second end of the anchor body, the second attachment member including a second mounting plate that is different from the first mounting plate and has an opening configured to be in communication with an interior of the anchor body, the opening configured to receive the one or more wires from the interior of the anchor body.

In some aspects, the techniques described herein relate to an anchor assembly, wherein the first mounting plate has a first mounting interface and the second mounting plate has a second mounting interface that is different from the first mounting interface.

In some aspects, the techniques described herein relate to an anchor assembly, wherein the first attachment member has a first engagement interface and the second attachment member has a second engagement interface that is the same as the first engagement interface, each of the first and second engagement interfaces configured to engage a complementary mating interface of the anchor body.

In some aspects, the techniques described herein relate to an anchor including: a body including a first end having a pointed or inclined tip, a second end opposite the first end, a wall defined between the first end and the second end, a first portion defined between the first end and a location between the first end and the second end, a helical plate coupled to the wall adjacent to the first end, a first aperture in the wall and in communication with an interior of the body, the aperture being in the first portion, the first aperture configured to receive one or more wires into the interior from an outside of the body, a second portion defined between the second end and the location, the second portion integrally formed with the first portion as a single-piece, a second aperture positioned between the first and the second end, the second aperture configured to receive the one or more wires from the interior of the body, and a bracket coupled to the second portion, the bracket configured to mechanically couple a housing of a charger for an electric vehicle while the one or more wires are mechanically and electrically coupled to the charger through the first and second apertures to power the charger, wherein the body is configured to be partially inserted into a ground via rotation which causes the helical plates to advance the first portion into the ground; and wherein the first portion is configured to be positioned under a surface of the ground and the second portion is configured to project from the ground such that the charger is supported by the second portion above the ground.

In some aspects, the techniques described herein relate to an anchor, wherein the bracket is a first bracket, the charger is a first charger, the one or more wires are one or more first wires, and further including a second bracket coupled to the second portion, the second bracket configured to mechanically couple a housing of a second charger for an electric vehicle while the one or more second wires are mechanically and electrically coupled to the charger to power the second charger.

In some aspects, the techniques described herein relate to an anchor, wherein the first bracket and the second bracket are spaced apart from one another about a periphery of the second portion.

In some aspects, the techniques described herein relate to an anchor, wherein the second end includes a tool mounting interface configured to removably couple to a tool for driving the body into the ground.

In some aspects, the techniques described herein relate to an anchor assembly including: an anchor including an anchor body having a first end having a pointed or inclined tip, a second end opposite the first end, a wall defined between the first end and the second end, a first portion defined between the first end and a location between the first end and the second end, a helical plate coupled to the wall adjacent to the first end, a first aperture in the wall of the anchor body, the first aperture being in the first portion and providing access to an interior of the anchor body, and a second portion defined between the second end and the location, the second portion integrally formed with the first portion as a single-piece, and a cap that is couplable to the second end, the cap including a cap body having a first end being an open end, a second end opposite the first end, a wall extending between the first end and the second end, and a second aperture in the wall of the cap body and in communication with an interior of the cap body, wherein the cap body is configured to be coupled to the anchor body, wherein the first aperture is configured to guide one or more wires from an outside of the anchor body through the interior of the anchor body and the interior of the cap body to the second aperture, wherein the cap body is configured to mechanically couple to a housing of a charger for an electric vehicle while the one or more wires are mechanically and electrically coupled to the charger to power the charger, wherein the anchor body is configured to be partially inserted into a ground via rotation which causes the helical plates to advance the first portion into the ground, and wherein the first portion is configured to be positioned at least partially under a surface of the ground and the second portion is configured to project from the ground such that the charger is supported by the second portion.

In some aspects, the techniques described herein relate to an anchor assembly, wherein the cap body is coupled to the anchor body before the anchor body is inserted into the ground.

In some aspects, the techniques described herein relate to an anchor assembly, wherein the cap body is coupled to the anchor body after the anchor body is inserted into the ground.

In some aspects, the techniques described herein relate to an anchor assembly, wherein the cap body is coupled to the anchor body by a fastener.

In some aspects, the techniques described herein relate to an anchor assembly, wherein a bracket is coupled the cap body, the bracket configured to mechanically couple the housing of the charger.

In some aspects, the techniques described herein relate to an anchor assembly, wherein a portion of the wall of the cap body adjacent the second aperture defines a device mounting interface for mechanically coupling the housing of the charger.

In some aspects, the techniques described herein relate to an anchor assembly, wherein the second end of the anchor includes a tool mounting interface configured to removably couple to a tool for driving the anchor body into the ground.

Other aspects of the application will become apparent by consideration of the detailed description and accompanying drawings.

### BRIEF DESCRIPTION OF THE DRAWINGS

FIG. 1A illustrates a schematic of an anchor according to an embodiment having a bracket with a mounting interface for mounting an electric device, such as an electric vehicle charger.

FIG. 1B illustrates an exemplary charger for an electric vehicle mounting to a wall.

FIG. 1C is a perspective view of the electric vehicle charger of FIG. 1B.

FIG. 1D is another perspective view of the electric vehicle charger of FIG. 1B.

FIG. 2 illustrates a schematic of an anchor assembly according to another embodiment of the invention, the anchor assembly including an anchor and a cap.

FIG. 3 illustrates a schematic of a pedestal for use with an anchor and including either the bracket of FIG. 1A or the cap of FIG. 2 or both.

FIG. 3A illustrates a perspective view of a pedestal for use with an anchor, the pedestal having a weather cap and a cover plate.

FIG. 3B illustrates a rear view of the pedestal of FIG. 3A.

FIG. 3C illustrates a side view of the pedestal of FIG. 3A.

FIG. 3D illustrates a front view of the pedestal of FIG. 3A.

FIG. 3E is a cross-sectional view of the pedestal of FIG. 3A along the line 3E—3E of FIG. 3C.

FIG. 3F illustrates a perspective view of another pedestal for use with an anchor, the pedestal having a mounting interface.

FIG. 3G illustrates a side view of the pedestal of FIG. 3F.

FIG. 3H illustrates a front view of the pedestal of FIG. 3F.

FIG. 3I illustrates a cross-sectional view of FIG. 3F along the line 3I—3I of FIG. 3H.

FIG. 3J illustrates a cross-sectional view of FIG. 3F along the line 3J—3J of FIG. 3G.

FIG. 3K illustrates a perspective of an anchor.

FIG. 3L illustrates a side view of the anchor of FIG. 3K.

FIG. 3M illustrates a top view of the anchor of FIG. 3K.

FIG. 3N is a detailed view of a portion of the anchor of FIG. 3N.

FIG. 3O illustrates a perspective of an anchor.

FIG. 3P illustrates a side view of the anchor of FIG. 3O.

FIG. 3Q is a detailed view of a portion of the anchor of FIG. 3P.

FIG. 3R illustrates a top view of the anchor of FIG. 3O.

FIG. 4 illustrates a schematic of an anchor assembly according to another embodiment.

FIG. 5 illustrates a schematic of a sheath for use with the anchor FIGS. 1A or 2 or pedestal or the pedestals of FIGS. 3, 3A, and 3F.

### DETAILED DESCRIPTION

Before any embodiments of the application are explained in detail, it is to be understood that the application, and the devices and method described herein, are not limited in their application to the details of construction and the arrangement of components set forth in the following description or illustrated in the following drawings. The devices and methods in this application are capable of other embodiments and of being practiced or of being carried out in various ways.

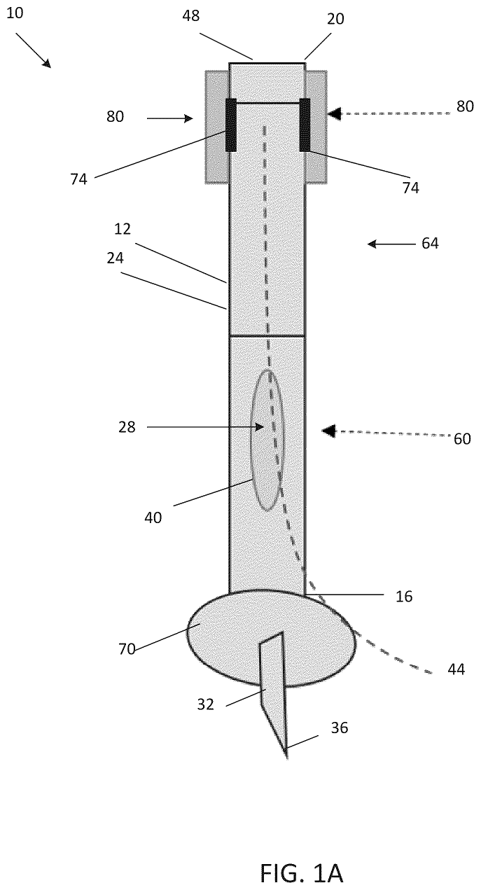

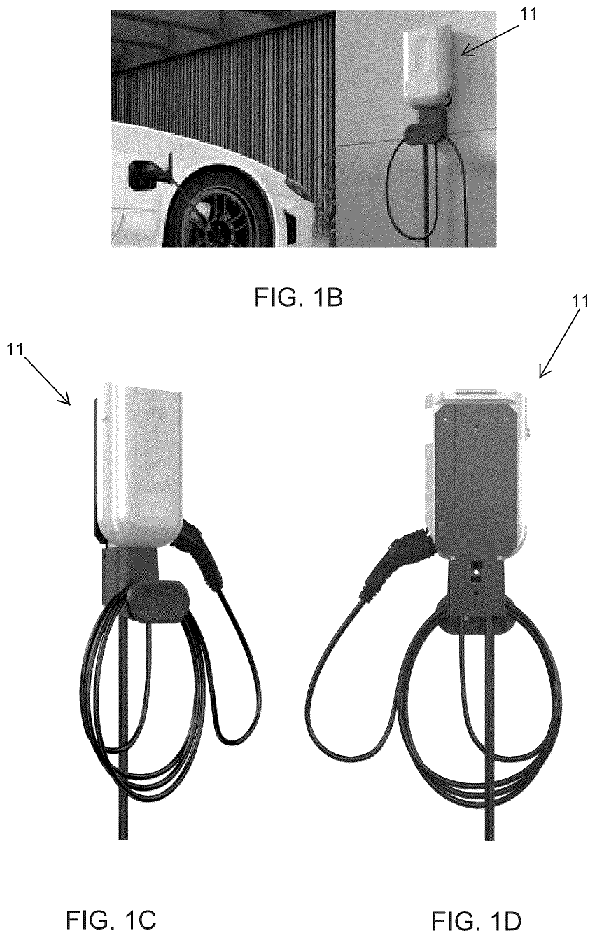

Referring now to the figures, in particular FIG. 1A and 2-4, an exemplary embodiment of an anchor 10 according to the present disclosure is shown. The anchor 10 may also be referred to as a “foundation,” “screw-in foundation,” or “helical pile”. The anchor 10 is configured to mount an electric vehicle charger 11, as shown in FIGS. 1B-1D, or another electric device. In this exemplary embodiment, the anchor 10 is a helical pile anchor having an anchor body 12. In the illustrated embodiment, the anchor body 12 is a straight pipe, tube, or shaft that may be round or square in shape, or any other shape, such as a hexagon shape. In the illustrated embodiments, the anchor body 12 includes a first end 16 and a second end 20 opposite the first end 16. A wall 24 extends between the first end 16 and the second end 20 and encloses a hollow interior 28 of the anchor body 12.

The first end 16 includes a projection 32 that has a pointed or inclined tip 36. An aperture 40 extends through the wall 24 and is in communication with the interior 28 of the anchor body 12. In the illustrated embodiment, the aperture 40 is positioned closer to the first end 16 than to the second end 20. The aperture 40 is configured to receive one or more wires 44 from the outside of the anchor body 12 into the interior 28 of the anchor body 12. In some embodiments, a tool mounting interface 48 may be coupled to the second end 20. The tool mounting interface 48 is configured to be coupled to a tool, as discussed in greater detail below.

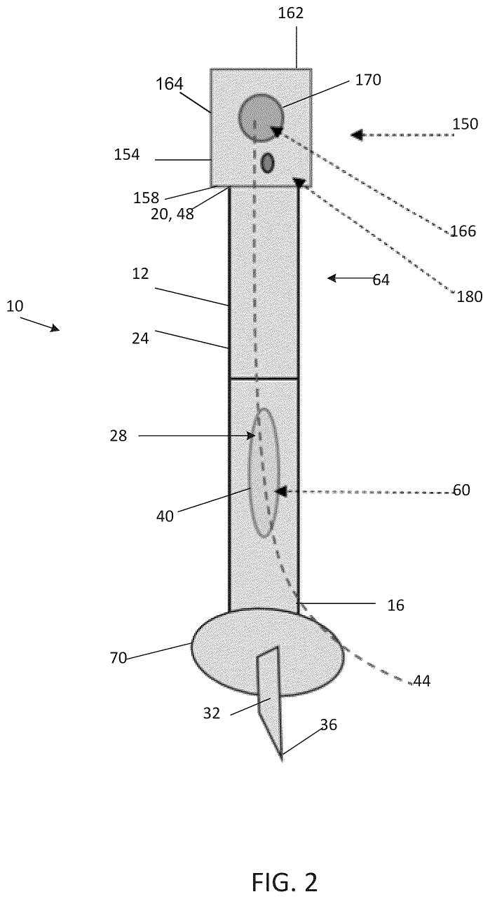

In the embodiment illustrated in FIGS. 1A and 2, the anchor body 12 has a first portion 60 and a second portion 64. In the illustrated embodiments, the first portion 60 and the second portion 64 are integrally formed as a single piece. The first portion 60 is defined between the first end 16 and a location between the first end 16 and the second end 20. The second portion 64 is defined between the second end 20 and the location. In the illustrated embodiment, the aperture 40 is in the first portion 60. Although not shown, in some embodiments, a bearing plate may be coupled to the wall 24 at the location or anywhere between the first end 16 and the second end 20. The bearing plate may integrally formed with the anchor body as a single-piece or otherwise coupled to the anchor body. The bearing plate may be configured to be supported by the ground when the anchor 10 is in use. In some cases, the bearing plate may include the tool mounting interface 48′ for driving the anchor into the ground, as discussed in greater detail below.

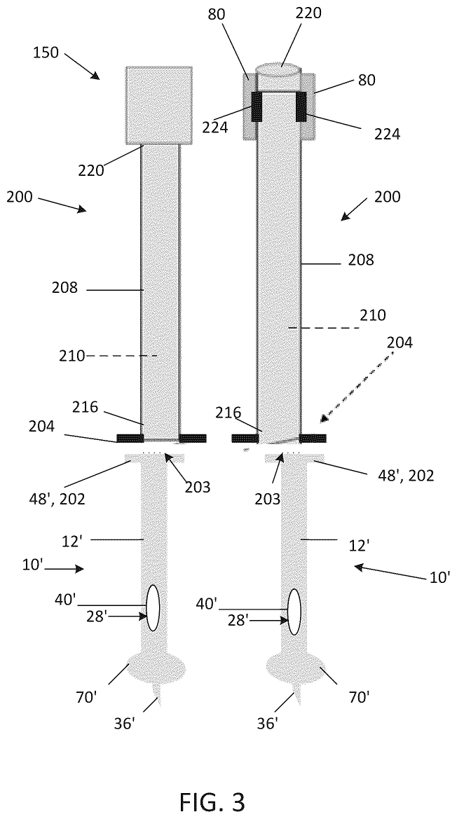

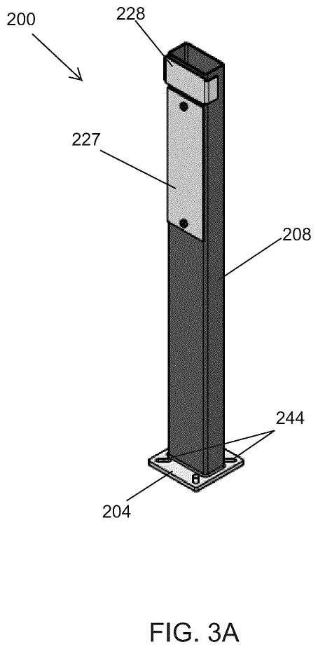

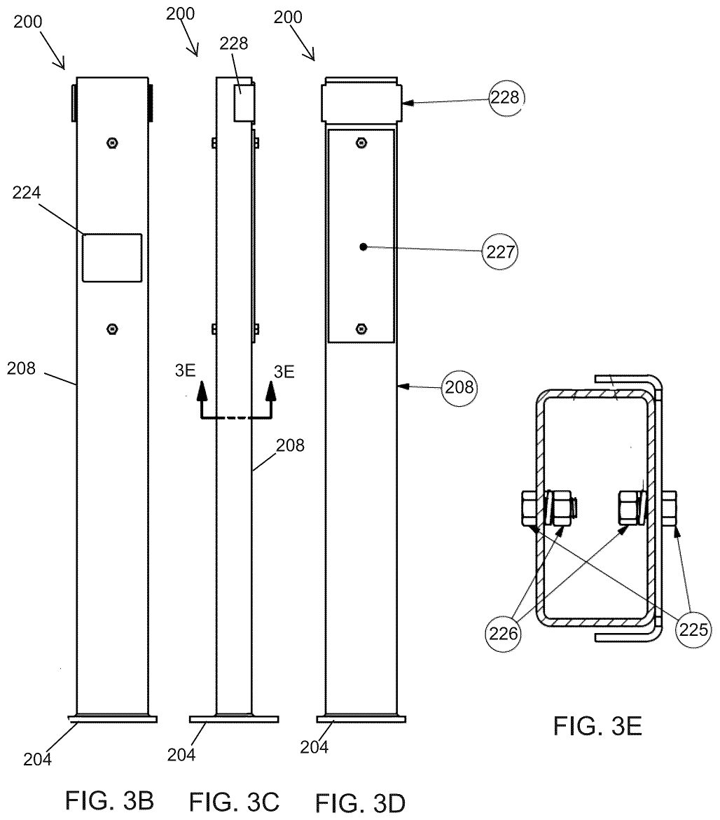

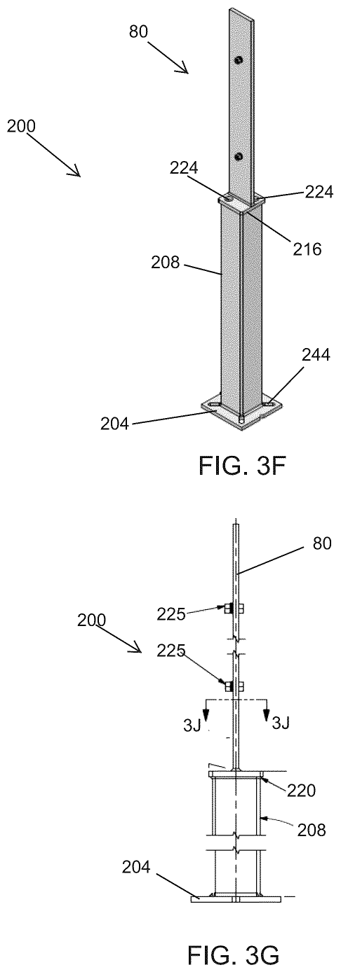

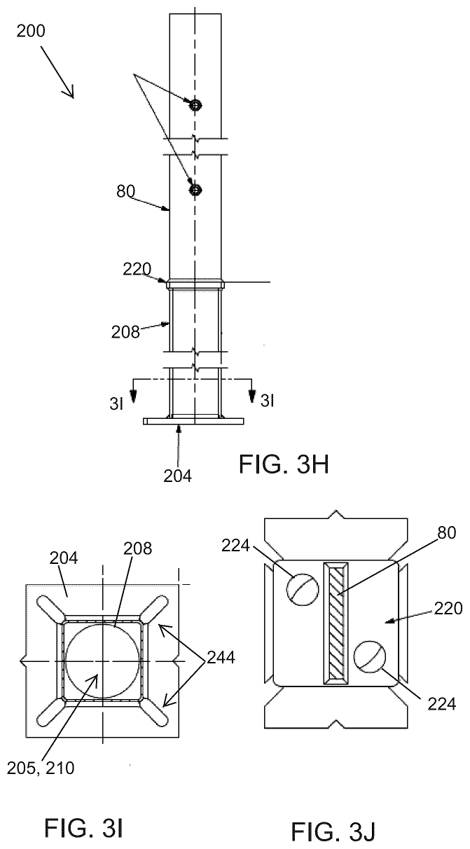

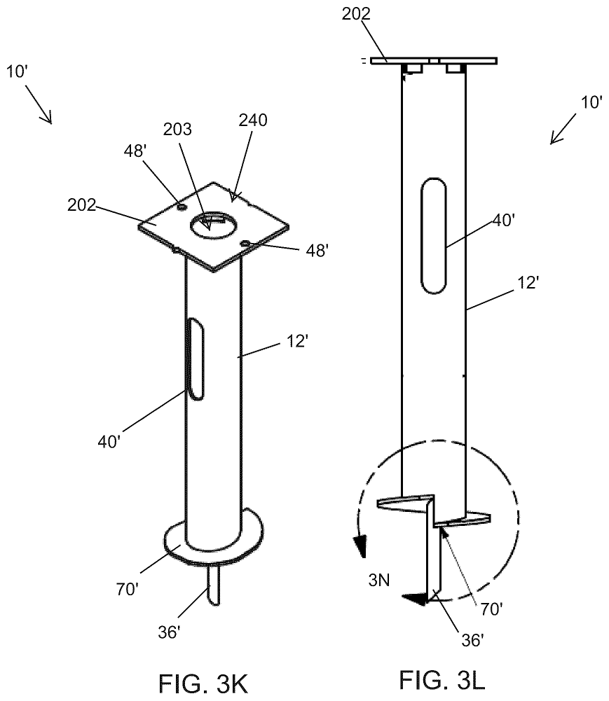

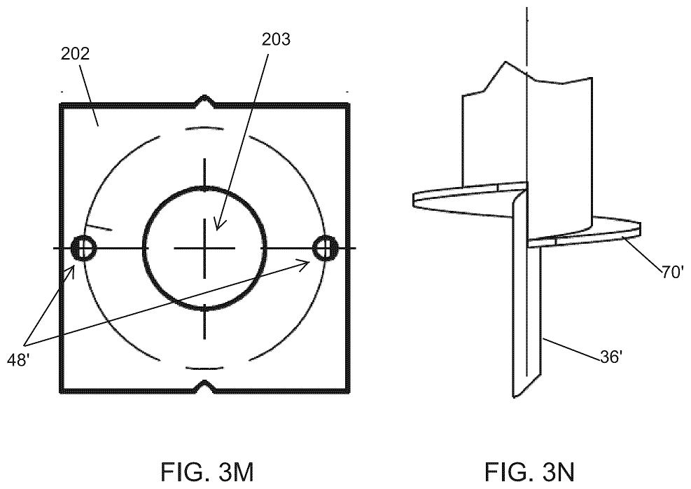

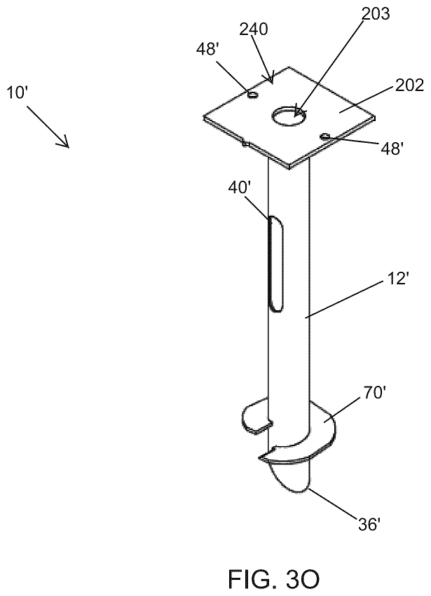

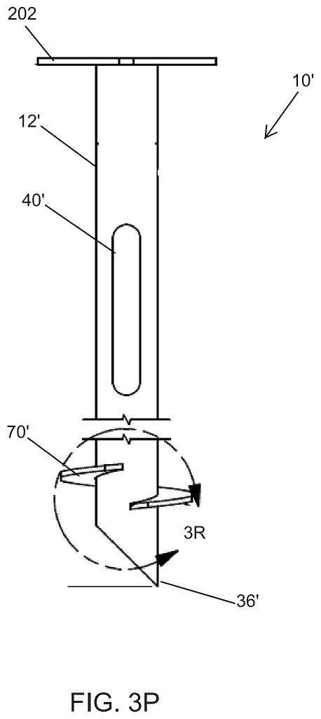

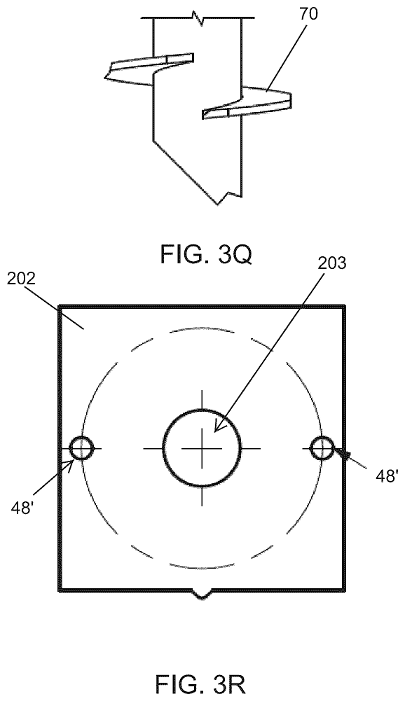

In the embodiment of FIG. 1A, the second end 20 is configured to couple to a tool (not shown) used to screw the anchor body 12 into the soil. Therefore, in some embodiments, the second end 20 may include the tool mounting interface 48 (e.g., including one or more apertures or elongated slots, shown in FIGS. 3K, 3M, 3O, and 3R) used for passing fasteners (e.g., bolts, not shown) therethrough. The fasteners may couple the second end 20, and therefore the anchor body 12, to the tool. Accordingly, rotation of the tool causes rotation of the anchor body 12.

At or near first end of the anchor body 12 is one or more load bearing helical plates 70 that, when rotated with the anchor body 12 (via the tool), screw the anchor 10, e.g., the helical pile, into the ground or other support surface with minimal disruption to the surrounding area.

The one or more load bearing helical plates 70 on the anchor body 12 may have the same diameter, or the load bearing helical plates 70 may have different diameters that are, for example, in a tapered arrangement. For example, the tapered arrangement may be such that the smallest diameter load bearing helical plate 70 is closest to the pointed tip 36 and the largest load bearing helical plate 70 is at a distance away from the pointed tip 36. If multiple load bearing helical plates 70 are employed, the load bearing helical plates 70 on the anchor body 12 would be spaced apart at a distance sufficient to promote individual plate 70 load bearing capacity, as is known. In the embodiment of the anchor 10 herein, a single load bearing helical plate 70 attached to the anchor body 12 is shown. The present disclosure also contemplates an anchor body 12 with multiple load bearing helical plates 70, where the distance between the load bearing helical plates 70 is preferably a multiple of the diameter of the lower load bearing helical plate.

Thus, the anchor body 12 is configured to be partially inserted into the ground via rotation of the same (via the tool) which causes the helical plates 70 to advance the anchor 10 into the ground. With respect to the embodiments of FIGS. 1A and 2, the first portion 60 is configured to be positioned under a surface of the ground and the second portion 64 is configured to project from the ground. When included, the bearing plate is configured to be supported by a surface of the ground.

In the embodiment of FIG. 1A, the tool mounting interface 48 is positioned at the second end 20. Also, the second end 20 of the anchor body 12 further includes a pair of apertures 74, each of which is adjacent to the second end 20. Also, a first bracket 80 and a second bracket 80 are coupled adjacent to the second end 20. The first bracket 80 corresponds to one aperture 74 and second bracket 80 corresponds to the other aperture 74. The brackets 80 are each configured to mechanically couple to a housing of an electric vehicle charger. That is, each of the brackets 80 includes a device mounting interface configured to mechanically couple to the housing of the electric vehicle charger. In the illustrated embodiment, the brackets 80 may be welded to the anchor body 12, but in other embodiments, the brackets 80 may be coupled to the anchor body 12 in other suitable ways (e.g., by fasteners, e.g., bolts). In the illustrated embodiment, there are two apertures 74 and two brackets 80, and therefore two chargers can be mechanically coupled to anchor body 12. In other or additional embodiments, the anchor body 12 may have a single bracket 80 (and therefore a single corresponding aperture 74) or more than two brackets 80 (and therefore more than two corresponding apertures 74). Regardless, the number of apertures 74 adjacent the second end 20 would correspond to the number of brackets 80 (and therefore chargers) intended to be coupled adjacent thereto.

The bracket 80 and the device mounting interface thereof may have any suitable configuration. For example, the device mounting interface of the bracket 80 may have one or more slots and/or apertures. One or more of the slots and/or apertures may be configured to movably receive a fastener. That is, a portion of a fastener may extend through one or more of the slots or apertures to be received in fastener hole (not shown) of the housing of the charger. The brackets 80 may be mechanically coupled to the housing of the charger in other suitable ways (e.g., by a snap-fit, friction-fit, detent mechanism, etc.).

In the illustrated embodiment, one of the apertures in each of the brackets 80 is positioned generally adjacent to the corresponding aperture 74 in the second end 20. The wires 44 inserted into the anchor body 12 through the aperture 40 are able to be guided through the interior 28 to the respective apertures 74 in the second end 20 and through the respective aperture in the brackets 80, such that wires can be mechanically and electrically coupled to the chargers to power the chargers.

As noted above, in the illustrated embodiment, because there are two brackets 80, two chargers may be coupled to the anchor 10. In the illustrated embodiment, the first and second brackets 80 are the same having the same device mounting interface, yet configured to be coupled to different mechanical mating structures (not shown) of different chargers. Accordingly, the first bracket 80 could be used to couple the housing of a first charger and the second bracket 80 could be used to couple to the housing of a second charger that is the same or different than the first charger. In other embodiments, the brackets 80 may be different from one another and may have different device mounting interfaces. Also, as shown, the apertures 74 and corresponding brackets 80 are positioned on opposite sides of the anchor body 12. In other embodiments, the apertures 74 and corresponding brackets 80 may be positioned at other locations about the periphery of the anchor body 12. Also, because the brackets 80 are positioned adjacent the second end 20, the brackets 80 couple the chargers such that they supported by the second portion 64 of the anchor body 12 above the ground. As shown, each of the brackets 80 of FIG. 1A are positioned at generally the same height relative to the ground. Accordingly, the chargers are positioned at generally the same height relative to the ground. In other embodiments, the brackets 80 (and therefore the apertures 74) may be positioned at different heights relative to one another such that the chargers may be positioned at generally different heights.

In the embodiment of FIG. 2, the second end 20 of the anchor body 12 is an open end. In such case, the wires 44 may extend through the second end 20. In other embodiments, the second end 20 may be a closed end and apertures 74 (like those of FIG. 1A) adjacent the second end 20 may extend through the wall 24. In such case, the wires 44 may extend through the apertures 74. Also, a cap 150 may be coupled to the second end 20. The cap 150 includes a cap body 154 that has a first end 158 and a second end 162 opposite the first end 158. In some embodiments, the tool mounting interface 48 may be positioned at the second end 162. A wall 164 of the cap body 154 extends between the first end 158 and the second end 162. The first end 158 is an open end providing access to an interior 166 of the cap body 154. Also, one or more apertures 170 may extend through the wall 164 of the cap body 154. The apertures 170 are in communication with the interior 166. In the illustrated embodiment, although only one is shown, there are two apertures 170 that extend through the cap body 154, one on opposite sides thereof. In other embodiments, there may be a single aperture 170 or more than two apertures 170.

In some embodiments, although not shown in detail in FIG. 2, a first bracket 80 and a second bracket 80 may be coupled to the cap 150. That is, like the embodiment of FIG. 1A, each of the brackets 80 may be coupled to the cap 150 adjacent to one of the apertures 170. The brackets 80 may be the same as those discussed above and therefore the details will not be repeated. The brackets 80 may be welded (or otherwise coupled) to the cap body 154 such that an aperture of each bracket 80 is adjacent to the corresponding aperture 170. As noted above, the brackets 80 have device mounting interfaces that are each configured to mechanically couple a housing of a charger thereto. In other embodiments, there may be a single bracket to couple a single charger or more than two brackets to couple more than two chargers. The apertures 170 and brackets 80 may be positioned at other locations relative to the cap body 154.

In some embodiments, although not shown in detail in FIG. 2, a portion of the wall 164 of the cap body 154 adjacent to each of the apertures 170 may be configured as a device mounting interface for mechanically coupling the housing of the charger. For example, the portion of the wall 164 may have a similar configuration to that of the device mounting interface of the brackets 80. That is, as discussed above, a plurality of slots and apertures may surround the respective aperture 170 in a pattern and one or more may receive a fastener therethrough for engaging with fastening holes (not shown) in the housing of the charger.

The cap 150 is configured to be coupled to the anchor 10. In particular, the cap body 154 is configured to be coupled to the anchor body 12 such that the open first end 158 of the cap 150 couples to the second end 20 of the anchor body 12. In the illustrated embodiment, the cap body 154 is coupled to the anchor body 12 via fasteners 180 (e.g., bolts, etc.). In other embodiments, the cap body 154 may be coupled in other ways (e.g., via a threaded engagement, detent mechanism, a snap fit engagement, or other suitable method). As discussed with respect to FIG. 1A, the aperture 40 in the anchor body 12 are configured to guide one or more wires 44 from the outside of the anchor body 12 to the apertures 170. That is, wires 44 may be guided through the aperture 40 of the anchor body 154 to the respective apertures 170 via the interior 28 of the anchor body 12 and the interior 166 of the cap body 154. Thus, the cap 150, via the wall 164 or brackets 80, is configured to mechanically couple to the housings of two chargers, each configured for an electric vehicle while the one or more wires 44 are mechanically and electrically coupled to the chargers to power the chargers. As shown, the cap 150 couples to the anchor body 12 such that the chargers are supported by the second portion 64 of the anchor 10 above the ground.

In some embodiments, the cap 150 may be coupled to the anchor body 12 before the anchor 10 is inserted into the ground. Accordingly, the tool mounting interface 48 may be included on at the second end of the cap 150, such that the cap 150 may be used to drive the anchor 10, with the cap 150, into the ground. In some embodiments, the cap 150 may be coupled to the anchor body 12 after the anchor 10 is inserted into the ground. In such case, the tool mounting interface 48 could be at the second end 20 of the anchor body 12, such that the anchor 10 may be driven into the ground prior to the cap 150 being coupled to the anchor 10.

In other embodiments, such as that of FIG. 3, the brackets 80 or the cap 150 (with or without brackets 80) may be coupled to a pedestal 200 that is couplable to an anchor 10′ having another configuration, which has similar features to the anchor 10 except as otherwise noted. The anchor 10′ is shown in FIGS. 3 and 3K-3R. As shown, the tool mounting interface 48′ of the anchor 10′ is part of a mounting plate 202 that is coupled to the second end 20′ of the anchor 10′. In addition to the tool mounting interface 48′, the mounting plate 202 includes an opening 203 that provides access to the interior 28′ of the anchor 10′. In some embodiments, the mounting plate 202 may have a pedestal mounting interface 240 that is complementary to an anchor mounting interface 244 of a mounting plate 204 of the pedestal 200. In some embodiments, the pedestal mounting interface 240 may be one or more apertures (not shown) defined in a pattern. In some embodiments, the aperture pattern may be individually drilled into the mounting plate 202 to fit the respective anchor mounting interface 244. Accordingly, with respect to FIGS. 3K, 3M, 3O, 3R, the mounting plate 202 may be blank except for the tool mounting interface 48′ and the aperture pattern later-added to suit the pedestal 200 to be coupled thereto. Like the anchor 10, the anchor 10′ includes the aperture 40′, the pointed or inclined tip 36, and the helical plate 70. In the embodiment of FIG. 3, the entire anchor 10′ is positioned within the ground when installed and the mounting plate 202 is at the surface of the ground. Once the anchor 10′ is installed, the pedestal 200 can be coupled to the mounting plate 202 thereof, as discussed further below. The anchor 10 may have different dimensions (e.g., outer and inner diameters/widths, wall thicknesses, mounting plate configurations, mounting plate dimensions, first end configurations, etc.) as shown in FIGS. 3K-3N and 3O-3R.

As shown in FIGS. 3, 3A, and 3F, the pedestal 200 may have various configurations. In all embodiments, the pedestal 200 has the mounting plate 204 having the anchor mounting interface 244 and a support member 208 coupled to and extending from the mounting plate 204. The support member 208 has a hollow interior 210 (FIG. 3I) that is accessible view an opening 205 (FIG. 3I) in the mounting plate 204. The support member 208 also has a first end 216 coupled to the mounting plate 204 and a second end 220 that is opposite the first end 216. The first end 216 is an open end that provides access to the interior 210. The second end 220 may be a closed end or an open end. If the second end 220 is a closed end, the pedestal 200 includes apertures 224 at or adjacent to the second end 220 that are in communication with the interior 210 of the pedestal 200. Accordingly, in some embodiments, as shown in FIG. 3, each of the brackets 80 having the device mounting interface may be positioned adjacent one of the apertures 224, as discussed above relative to the embodiment of FIG. 1A. In other embodiments, the apertures 224 may be positioned elsewhere in the periphery of the pedestal such that the brackets 80 are positioned at other location relative to the pedestal 200. As shown in FIG. 3, if the second end 220 is an open end, the cap 150 may be coupled to the second end 220, as discussed above relative to the embodiment of FIG. 2. In still other embodiments, shown in FIG. 3B, the device mounting interface may be defined by one or more areas of the pedestal 200 adjacent to and surrounding the apertures 224. For example, in FIG. 3B, the device mounting interface includes apertures (not shown) positioned on opposite sides of the aperture 224 for receiving bolts 225 (mated with nuts 226) that couple to the housing of the electric vehicle charger. In still other embodiments, shown in FIGS. 3G and 3H, the bracket 80 having the device mounting interface may project from a second end 220 of the pedestal 200. In such case, the apertures 224 are positioned at the second end 220. In the embodiment of FIG. 3G, the bracket 80 is integrally formed with the pedestal 200 as a single-piece, but in other embodiments, the bracket 80 may be coupled to the second end 220 of the pedestal in other ways. In some embodiments, such as FIGS. 3A-3E, the pedestal may further include a cover plate 227 configured to be removably coupled to the support member 308 and a weather cap 228 configured to be removably coupled to the support member 208.

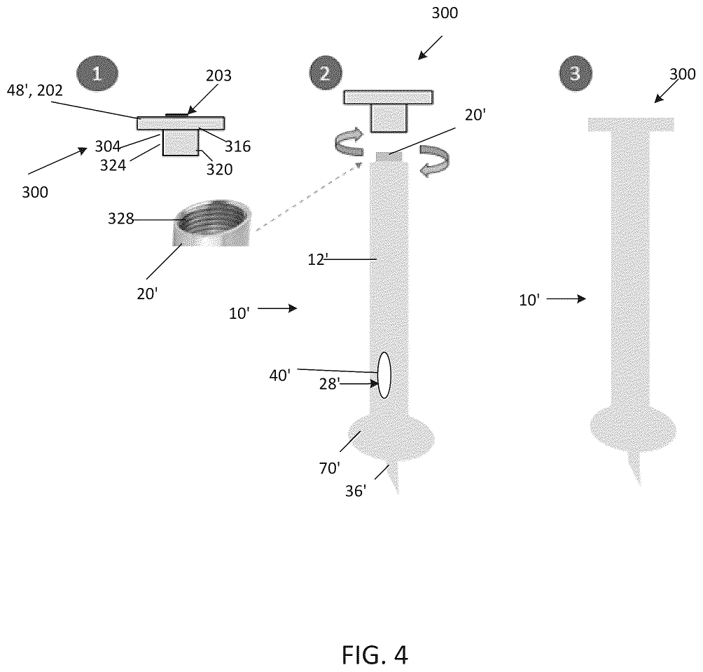

The mounting plate 204 of the pedestal 200 may be coupled to the mounting plate 202 of the anchor 10′ such that the support member 208 extends from the surface of the ground. Specifically, the mounting interfaces 240, 244 of the respective mounting plates 202, 204 are configured to align for coupling via fasteners (e.g., bolts) or the like. Accordingly, the entire pedestal 200 extends from the surface of the ground. The chargers, which are coupled to the pedestal 200 via brackets 80, the cap 150, or otherwise, are therefore supported above the surface of the ground. Moreover, the opening 205 of the pedestal 200 is configured to be positioned adjacent the opening 203 in the mounting plate 202 of the anchor 10′ such that the interior 210 of the pedestal 200 is in communication with interior 28′ of the anchor 10′. Accordingly, wires (not shown in FIG. 4) may be routed from the aperture 40′ in the anchor body 12′ through the interior 28′ of the anchor body 12′ and the interior 210 of the pedestal 200 to the apertures 224 thereof. The wires are therefore accessible at or adjacent to the second end 220, as discussed above with respect to FIGS. 1A and 3, to mechanically and electrically couple to the chargers to power the chargers.

As shown in FIG. 4, the mounting plate 202 may be part of an attachment member 300 that is removably couplable to the second end 20′ of an anchor 10′. In this way, attachment member 300 can be interchangeable with another attachment member 300, as discussed in greater detail below. The attachment member 300 is described herein as being used with the anchor 10′, but in other embodiments, the attachment member 300 may be used with the anchor 10 instead. In the embodiment of FIG. 4, the attachment member 300 may include a hollow body 304 and the mounting plate 202 having the opening 203, the tool mounting interface 48′, and the pedestal mounting interface 240. The hollow body 304 includes a first end 316 and a second end 320 opposite the first end 316. The mounting plate 202 is coupled to the second end 320 of the hollow body 304 and the opening 203 in the mounting plate 202 is in communication with an interior of the hollow body 304. The attachment member 300, and the mounting plate 202 thereof, may be used to couple a pedestal 200 (described above) including a charger for an electric vehicle (as discussed above) or a pedestal carrying another suitable electric device. In other embodiments, the mounting plate 202 may alternatively coupled to any other suitable electric device (e.g., an outdoor light, a pole mounted 5G small cell antenna, etc.).

As shown, the attachment member 300 is configured to be coupled to the second end 20′ of the anchor body 12′ such that the opening 203 in the mounting plate 202 is in communication with the interior 28′ of the anchor body 12′. In the illustrated embodiment, the hollow body 304 has a first engagement interface 324 and the second end 20′ of the anchor body 12′ has second engagement interface 328 that is configured to matingly receive the first engagement interface 324 of the hollow body 304. In other embodiments, the first engagement interface 324 may be configured to matingly receive the second engagement interface 328, instead. In the illustrated embodiment, the first engagement interface 324 is a threaded interface and the second engagement interface 328 is a threaded interface. Accordingly, the hollow body 304 (and therefore the attachment member 300) is coupled to the second end 20′ of the anchor body 12′ via threaded engagement between the first and second threaded interfaces 324, 328. In the illustrated embodiment, the threaded interfaces are configured opposite the direction of rotation of insertion of the anchor 10′. The first and second engagement interfaces 324, 328 may have other configurations. For example, one of the hollow body 304 and the anchor body 12′ may include a detent aperture (not shown) and the other of the hollow body 304 and the anchor body 12′ may include a detent that is configured to be removably received in the detent aperture to couple the hollow body 304 (and therefore the attachment member) to the anchor body. That is, the first or second engagement interface may be a detent, while the other of the first or second engagement interface may be a detent aperture. In other embodiments, the hollow body 304 may be coupled to the anchor body 12′ via a fastener (e.g., a bolt). Regardless, in any embodiment, the attachment member 300 is configured to be locked (via the engagement interfaces, fasteners, or other suitable locking mechanism) relative to the anchor body 12.

The attachment member 300 may be a first attachment member with the first mounting plate 202 may have a first pedestal mounting interface 240′ configured to couple a pedestal 200 having one anchor mounting interface 244′. If necessary, the first attachment member 300 having the first mounting plate 202 with the first pedestal mounting interface 240′ may be interchangeable with a second attachment member 300 having a second mounting plate 202 with a second pedestal mounting interface 240′ that is different than the first pedestal mounting interface 240′. The second pedestal mounting interface 240′ may be suitable for coupling another pedestal having another anchor mounting interface 244′. The second attachment member 300 has the same first engagement interface 324 for coupling to the complementary second engagement interface 328 of the anchor body 12′. Accordingly, the second mounting plate 202 with the second pedestal mounting interface 240′ can be coupled to the anchor body 12′. In this way, changes in design of the pedestal or electric device do not require an entirely new anchor 10′. Rather, one need only swap out the attachment member 300 with the first pedestal mounting interface 240′ for another attachment member 300 with the appropriate second pedestal mounting interface 240′. Such a change is quicker and less cumbersome to make.

Although the attachment member 300 shown herein has having the hollow body 304 extending from the mounting plate 202 and used to couple the mounting plate to the anchor body 12, in other embodiments the hollow body may be omitted. In such case, the mounting plate 202 would include the first engagement interface 324 (e.g., threaded interface, detent/detent aperture, etc.), such that the mounting plate 202 itself would couple to the anchor body 12.

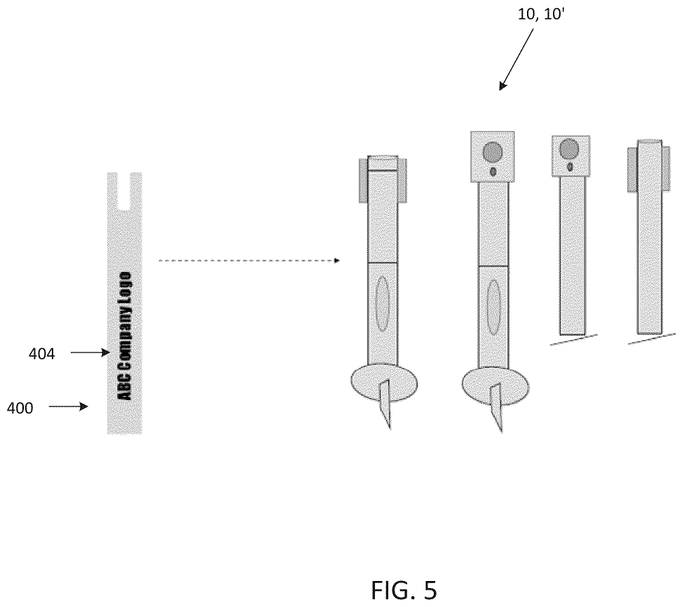

In some embodiments, as shown in FIG. 5, a sheath 400 may be coupled to the second portion 64 of the anchor 10 (FIGS. 1A and 2) or the support member 208 of the pedestal (FIG. 3). The sheath 400 may include identifying indicia 404 (e.g., logos, etc.).

The anchor body 12, 12′ of each of the anchors 10, 10′ is fabricated from a rigid material capable of supporting the particular load the anchor is intended to support. Examples of suitable rigid materials include steel, galvanized steel, aluminum, cast aluminum, and other alloys, as well as non-metallic materials such as carbon fiber. The length of the first portion 60 of the anchor body 12 of the anchor 10 and the anchor body 12′ of the anchor 10′ for a particular installation would depend upon the load the anchor 10 is to carry, the soil conditions, and the type of structure the anchor is intended to support.

Various features and advantages of the application are set forth in the following claims.

What is claimed is:

1. An anchor assembly comprising:
an anchor including an anchor body having
a first end having a pointed or inclined tip,
a second end opposite the first end,
a wall defined between the first end and the second end,
a helical plate coupled to the wall adjacent to the first end, and
an aperture in the wall of the anchor body, the aperture positioned between the helical plate and the second end, the aperture configured to receive one or more wires therethrough, and
an attachment member that is removably couplable to the second end of the anchor body, the attachment member including a mounting plate having an opening configured to be in communication with an interior of the anchor body, the opening configured to receive the one or more wires from the interior of the anchor body,
wherein the anchor body is configured to be partially inserted into a ground via rotation of the mounting plate which causes rotation of the anchor body such that the helical plate advances the anchor body into the ground, and
wherein the mounting plate is configured to mechanically couple to a housing of an electric device or a pedestal for coupling the housing of the electric device while the one or more wires are mechanically and electrically coupled to the electric device to power the electric device.

2. The anchor assembly of claim 1, wherein the attachment member further includes a hollow body having a first end and a second end opposite the first end, the mounting plate coupled to the second end such that the opening is in communication with an interior of the hollow body.

3. The anchor assembly of claim 2, wherein the hollow body includes a first engagement interface that is configured to matingly engage with a second engagement interface of the anchor body.

4. The anchor assembly of claim 2, wherein the hollow body includes a first threaded interface that is configured to matingly engage with a second threaded interface of the anchor body.

5. The anchor assembly of claim 2, wherein one of the hollow body and the anchor body includes a detent aperture and the other of the hollow body and the anchor includes a detent that is configured to be removably received in the detent aperture to couple the hollow body to the anchor body.

6. The anchor assembly of claim 2, wherein the hollow body is coupled to the anchor body via a fastener.

7. The anchor assembly of claim 1, wherein the attachment member is a first attachment member and the mounting plate is a first mounting plate and wherein the first attachment member is interchangeable with second attachment member that is removably couplable to the second end of the anchor body, the second attachment member including a second mounting plate that is different from the first mounting plate and has an opening configured to be in communication with an interior of the anchor body, the opening configured to receive the one or more wires from the interior of the anchor body.

8. The anchor assembly of claim 7, wherein the first mounting plate has a first mounting interface and the second mounting plate has a second mounting interface that is different from the first mounting interface.

9. The anchor assembly of claim 7, wherein the first attachment member has a first engagement interface and the second attachment member has a second engagement interface that is the same as the first engagement interface, each of the first and second engagement interfaces configured to engage a complementary mating interface of the anchor body.

10. An anchor comprising:
a body including
a first end having a pointed or inclined tip,
a second end opposite the first end,
a wall defined between the first end and the second end,
a first portion defined between the first end and a location between the first end and the second end,
a helical plate coupled to the wall adjacent to the first end,
a first aperture in the wall and in communication with an interior of the body, the aperture being in the first portion, the first aperture configured to receive one or more wires into the interior from an outside of the body,
a second portion defined between the second end and the location, the second portion integrally formed with the first portion as a single-piece,
a second aperture positioned between the first and the second end, the second aperture configured to receive the one or more wires from the interior of the body, and
a bracket coupled to the second portion, the bracket configured to mechanically couple a housing of a charger for an electric vehicle while the one or more wires are mechanically and electrically coupled to the charger through the first and second apertures to power the charger,
wherein the body is configured to be partially inserted into a ground via rotation which causes the helical plates to advance the first portion into the ground; and
wherein the first portion is configured to be positioned under a surface of the ground and the second portion is configured to project from the ground such that the charger is supported by the second portion above the ground.

11. The anchor of claim 10, wherein the bracket is a first bracket, the charger is a first charger, the one or more wires are one or more first wires, and further comprising a second bracket coupled to the second portion, the second bracket configured to mechanically couple a housing of a second charger for an electric vehicle while the one or more second wires are mechanically and electrically coupled to the charger to power the second charger.

12. The anchor of claim 11, wherein the first bracket and the second bracket are spaced apart from one another about a periphery of the second portion.

13. The anchor of claim 10, wherein the second end includes a tool mounting interface configured to removably couple to a tool for driving the body into the ground.

14. An anchor assembly comprising:
an anchor including an anchor body having
a first end having a pointed or inclined tip,
a second end opposite the first end,
a wall defined between the first end and the second end,
a first portion defined between the first end and a location between the first end and the second end,
a helical plate coupled to the wall adjacent to the first end,
a first aperture in the wall of the anchor body, the first aperture being in the first portion and providing access to an interior of the anchor body, and
a second portion defined between the second end and the location, the second portion integrally formed with the first portion as a single-piece, and
a cap that is couplable to the second end, the cap including a cap body having
a first end being an open end,
a second end opposite the first end,
a wall extending between the first end and the second end, and
a second aperture in the wall of the cap body and in communication with an interior of the cap body,
wherein the cap body is configured to be coupled to the anchor body,
wherein the first aperture is configured to guide one or more wires from an outside of the anchor body through the interior of the anchor body and the interior of the cap body to the second aperture,
wherein the cap body is configured to mechanically couple to a housing of a charger for an electric vehicle while the one or more wires are mechanically and electrically coupled to the charger to power the charger,
wherein the anchor body is configured to be partially inserted into a ground via rotation which causes the helical plates to advance the first portion into the ground, and
wherein the first portion is configured to be positioned at least partially under a surface of the ground and the second portion is configured to project from the ground such that the charger is supported by the second portion.

15. The anchor assembly of claim 14, wherein the cap body is coupled to the anchor body before the anchor body is inserted into the ground.

16. The anchor assembly of claim 14, wherein the cap body is coupled to the anchor body after the anchor body is inserted into the ground.

17. The anchor assembly of claim 14, wherein the cap body is coupled to the anchor body by a fastener.

18. The anchor assembly of claim 14, wherein a bracket is coupled the cap body, the bracket configured to mechanically couple the housing of the charger.

19. The anchor assembly of claim 14, wherein a portion of the wall of the cap body adjacent the second aperture defines a device mounting interface for mechanically coupling the housing of the charger.

20. The anchor assembly of claim 14, wherein the second end of the anchor includes a tool mounting interface configured to removably couple to a tool for driving the anchor body into the ground.
